(19) United States
(12) Patent Application Publication
(10) Pub. No.: US 2015/0016001 A1
(43) Pub. Date: Jan. 15, 2015

(54) PREVENTING MOISTURE DAMAGE TO A DEVICE

(71) Applicant: International Business Machines Corporation, Armonk, NY (US)

(72) Inventors: Aaron J. Quirk, Cary, NC (US); David A. Sakmar, Butner, NC (US); Carlos L. Torres, Durham, NC (US); Lin Sun, Morrisville, NC (US); Rohith K. Ashok, Apex, NC (US)

(21) Appl. No.: 13/939,540

(22) Filed: Jul. 11, 2013

Related U.S. Application Data
(63) Continuation of application No. 13/938,484, filed on Jul. 10, 2013.

(51) Int. Cl. H02H 5/08; H02H 11/00

(52) U.S. Cl. CPC H02H 5/083; H02H 11/00
USPC 361/78

(57) ABSTRACT

A method, device and computer program product for preventing moisture damage to electronic circuitry of a device may include monitoring for a predetermined capacitance criterion on a surface of the device; and automatically powering off the device in response to detecting the predetermined capacitance criterion.

### CROSS REFERENCE TO RELATED APPLICATIONS

This application is a continuation of U.S. patent application Ser. No. 13/938,484, filed on Jul. 10, 2013, the contents of which are hereby incorporated by reference in their entirety.

### BACKGROUND

Aspects of the present invention relate to collaborative creation and editing of documents or the like, and more particularly to a method and system for notification of a change to user selected content in a document.

Aspects of the present invention relate to electronic devices including but not limited to mobile communications devices, and more particularly to a method, system and computer program product for preventing moisture damage to a device.

Water damage to mobile communications devices is a common occurrence. As these devices are integrated into the daily routines of people, the devices are often carried at all times and all places. Opportunity for an accident around water is very real. The cost of replacing a mobile device, especially a high end smartphone, can be expensive. Accordingly, an effort to prevent water damage is highly desirable. The obvious choice is to design a device that is waterproof. However, engineering such a device is not without its disadvantages. The engineering and manufacturing of a completely sealed and waterproof device will significantly increase the cost of the device. Dissipation of heat generated during operation of sealed waterproof device may also present challenges. Waterproofed devices may also be bulky and visually unappealing. Standard wear and tear to the device may result in a water barrier being broken down over time. Current aftermarket waterproofing options may potentially void the warranty on the device. Waterproofed devices may also require additional steps during servicing to ensure successful resealing which may be costly and may require shipping the device to a remote service provider causing the consumer to be without use of the device for an extended period of time.

Additionally, devices which have been exposed to water or other liquids actually experience damage after the user powers the device on before the electronic components, particularly within the device have fully dried. When current flows over the wet device, short circuits result in permanent damage. Accordingly, a system is needed to prevent power from being restored to a device that has presence of moisture to a level that may result in permanent damage.

### BRIEF SUMMARY

According to one aspect of the present invention, a method for preventing moisture damage to electronic circuitry of a device may include monitoring for a predetermined capacitance criterion on a surface of the device. The method may also include automatically powering off the device in response to detecting the predetermined capacitance criterion.

According to another aspect of the present invention, a method for preventing moisture damage to electronic circuitry of a device may include monitoring for a predetermined capacitance criterion on a surface of the device. The method may also include monitoring a moisture level within an interior of the device. The method may additionally include automatically powering off the device in response to at least one of detecting the predetermined capacitance criterion on the surface of the device or detecting the moisture level of the interior of the device exceeding a preset threshold. The method may further include preventing the device from being powered back on in response to a moisture level within the interior of the device exceeding the preset threshold.

Accordingly to another aspect of the present invention, a method for preventing moisture damage to electronic circuitry of a device may include detecting a liquid contacting a surface of the device. The method may also include detecting a moisture level within an interior of the device. The method may further include automatically powering off the device in response to an amount of the liquid contacting the surface of the device exceeding a predetermined criterion or the moisture level of the interior of the device exceeding a preset threshold.

According to another aspect of the present invention, a device may include a processor and a module operable on the processor for monitoring for a predetermined capacitance criterion on a surface of the device. The device may be automatically powered off in response to detecting the predetermined capacitance criterion.

According to an additional aspect of the present invention, a device, comprising a processor and a module operable on the processor for monitoring for a predetermined capacitance criterion on a surface of the device. The device may be automatically powered off in response to detecting the predetermined capacitance criterion. The device may also include a moisture detection system for monitoring a moisture level within an interior of the device. The moisture detection system may be adapted to automatically power off the device in response to detecting the moisture level within the interior of the device exceeding a preset threshold and the moisture detection system being adapted to prevent the device from being powered on in response to detecting the moisture level within the interior of the device exceeding a preset threshold.

According to a further aspect of the present invention, a computer program product for preventing moisture damage to electronic circuitry of a device may include a computer readable storage medium having computer readable program code embodied therewith. The computer readable program code may include computer readable program code configured to monitor for a predetermined capacitance criterion on a surface of the device. The computer readable program code may also include computer readable program code configured to automatically power off the device in response to detecting the predetermined capacitance criterion.

### BRIEF DESCRIPTION OF THE SEVERAL VIEWS OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIGS. 1A and 1B (collectively FIG. 1) are a flowchart of an example of a method for preventing moisture damage to a device in accordance with an embodiment of the present invention.

FIG. 2 is a flow chart of an example of a method for providing an alert of a potential moisture or water hazard in accordance with an embodiment of the present invention.

FIG. 3 is a block schematic diagram of an example of an electronic device including a feature for preventing moisture or water damage to the device in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The present invention may include a two fold approach to preventing moisture damage to a device. As used herein, moisture damage may include but is not necessarily limited to water damage or damage from other liquids. Additionally, device may be any type of electronic device, including but not necessarily limited to mobile devices, communications devices, such as smart phones and other cell phones, computer devices, tablet computers and similar electronic devices. First in the two fold approach, the known capacitance of water and other liquids may be utilized to detect when significant amount of water or amount of water that exceeds a preset threshold comes into contact with an exterior surface of the device. When this state is detected, electrical power is immediately disconnected or removed from electrically powered components of the device to prevent physical damage. Second, a sealed, waterproof and self-powered closed loop system is used to prevent electrical power from being reconnected to the electronic components of the device when water is detected within the interior of the device. This second feature is a safety measure to prevent current from flowing over wet electronics that may cause permanent damage. Accordingly, a presence of moisture which may be water or another liquid is detected on the exterior surface of the device. The device is automatically powered off in response to detecting an amount of moisture exceeding a preset threshold amount. Electrical power is prevented from being restored to the device in response to the moisture level within the interior of the device exceeding the preset threshold. An indication may also be provided to a user that moisture (water or other liquid) has penetrated within the device.

A feature may also be provided to determine a geographic location of the device and provide an indication or warning to the user of the existence of any nearby water or moisture causing hazards. A particular mode may also be set that enables detection of movement of the device exceeding a certain criterion or criteria. The device may be automatically powering off in response to the movement of the device exceeding the certain criterion or criteria. An example of the certain criterion or criteria may include the mobile device being dropped into water or a sufficient amount of water being spilled or poured on the device that may result in moisture penetrating into the interior of the device and causing damage to the internal electronics of the device.

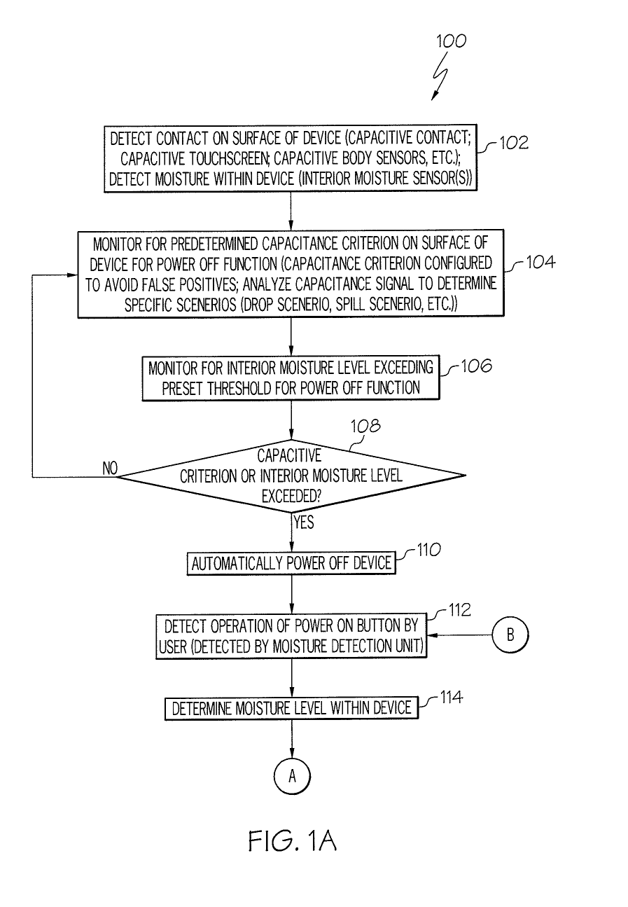

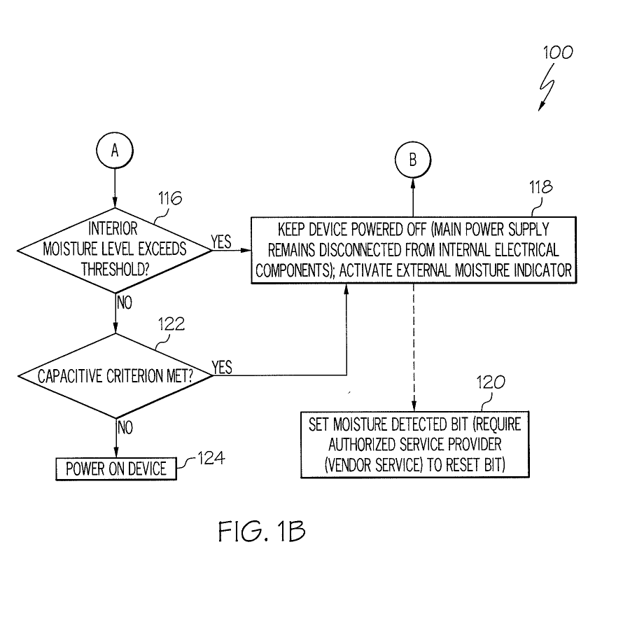

FIGS. 1A and 1B (collectively FIG. 1) are a flowchart of an example of a method 100 for preventing moisture damage to a device in accordance with an embodiment of the present invention. In block 102, moisture contact on a surface of a device may be detected. As previously discussed, the moisture contact may be water or another liquid in contact with a surface of the device. The contact detected may be capacitive contact. For example, the device may include a capacitive touchscreen, capacitive sensors provided in the body of the device or other mechanisms for detecting the moisture on the surface.

Most smart phones and other mobile devices have a touchscreen to detect physical movement of a human finger over the surface of the touchscreen. While there are many touchscreen technologies, projected capacitive touchscreens are most commonly used in mobile devices because they are less expensive and support multi-touch interfaces. The capacitance based touchscreen is essentially a device that measures capacity over a surface grid and translates change in capacity to screen coordinates. Changes in capacity are caused by the known capacitance of the human body which makes the touchscreen a useful input device.

Water also has a known capacity that is distinct from capacitance of the human body. In the case that water comes into contact with the touchscreen, the capacitance will be a predictable value just as it is for the human finger. The mobile device software may be augmented to monitor for this predictable capacitance of water and other liquids, and may be utilized as a trigger mechanism as described herein to automatically power off the device to prevent water or moisture damage. Once water or moisture is detected on the surface of the device, an immediate power off is initiated on the device. This power off preferably occurs before water or moisture reaches the interior of the device, where the moisture can cause damage.

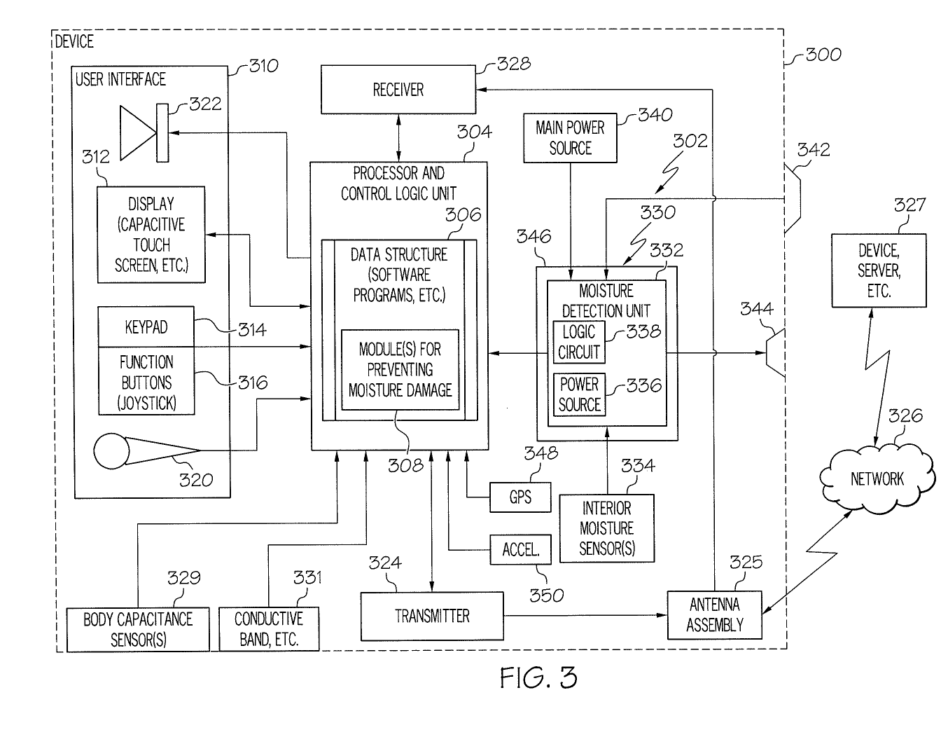

Moisture within the device may also be detected in block 102. As described in more detail with reference to FIG. 3, an interior moisture sensor or sensors may detect moisture and provide a signal or signals to a moisture detection unit corresponding to the amount of moisture detected within the device. The moisture detection unit may perform a power off function in response to the interior moisture level exceeding a preset threshold.

In block 104, a predetermined capacitance criterion or criteria may be monitored on the surface of the device for performing a power off function. The predetermined capacitance criterion may correspond to an amount of moisture on the surface of the device that causes a change in capacitance or generates a capacity value that exceeds a predetermined level or value or extends over a predetermined area of the surface of the device. The capacitance criterion may be configured to avoid false positives. In other words, the power off function will be performed only when the detected capacitance corresponds to a sufficient amount of water or moisture or covers a sufficient amount of surface area of the device that could result in possible damage to the device if the water or moisture penetrates the interior of the device. For example, if the device immediately powers off after only a few drops of water (rain, mist, etc.) contact the surface of the device, this would be frustrating for the user. In block 104, the capacitance signal may be analyzed to determine if sufficient moisture is in contact with the surface of the device and/or in contact over a sufficient area of the surface of the device over a given period of time that may result in moisture damage. Exemplary scenarios may be provided for the power off function to be performed. These scenarios may include but are not necessarily limited to a “drop scenario” when the device may be dropped into a body of water and “a spill scenario” where an amount of water is spilled or poured onto the device. If neither of these scenarios are detected, the device may not be automatically powered off.

The “drop scenario” may refer to a situation where the device is submerged into a body of water. Examples may include dropping the device into a sink full of water, accidentally jumping into a swimming pool when the device is in user's pocket, getting on an amusement park ride where the user is heavily splashed with water, or similar situation. This scenario is detected by the device when water is detected or sensed sweeping across the touchscreen and/or device body in a linear motion. As described in more detail below, the phone body may include capacitance sensors or other mechanisms similar to the touchscreen for detecting water or other liquids sweeping across the body. The touchscreen includes an accurate event grid that can provide location information or data in coordination with the ability to detect a known capacitance at specific grid coordinates that makes detecting water sweeping or flowing across the touchscreen possible. Additionally, this location data may be correlated with an internal accelerometer of the device for determination that the device may be falling or is being dropped.

The “spill scenario” may refer to a situation where water is spilled or poured onto the device. As an example, the device may be on a table and a cup of water or other liquid is spilled onto the device. This scenario may be detected when the water event is observed or detected radiating outward from a point on the phone. While other scenarios may be included, the drop and spill scenario may cover the majority of water events or similar incidents with other liquid that may result in moisture damage to the device, while also reducing the likelihood errantly powering off the device.

In addition to the touchscreen, the body of the device may also be used to detect and measure capacitance. For example, a capacitance sensor or sensors may be formed in the body at a selected location or locations. In one exemplary embodiment, a metal ring or band may be disposed around an exterior perimeter of the body and may be adapted to measure or sense capacitance. This additional capacitance measure may be used as a correlation data point to verify how severe the water or liquid exposure is. For instance if water or liquid is detected both on the screen and on the device body, there may be a higher probability that device is exposed to a significant amount of water volume or liquid.

In block 106, a moisture level within an interior of the device may also be monitored for performance of a power off function in response to the interior moisture level exceeding a preset threshold. Monitoring the interior moisture level may be a backup to monitoring for the predetermined capacitance criterion on the surface of the device for performing the power off function to protect the device from moisture damage.

In block 108, a determination may be made if the predetermined capacitance criterion has been met or whether the interior moisture level has exceeded the preset threshold. If neither of these conditions exist, the method 100 may return to block 104 and the method 100 may continue similar to that previously described. If either the predetermined capacitance criterion has been met or the interior moisture level has exceeded the preset threshold, the method 100 may advance to block 110. In block 110, the device may be automatically powered off.

In block 112, operation of a “power on” button or switch by a user may be detected. The operation of the power on button by the user may be detected by a moisture detection unit similar to that described with reference to FIG. 3 below.

In block 114, the moisture level within the device may be determined in response to detecting operation of the power on button. In block 116, a determination may be made if the interior moisture level within the device exceeds a preset threshold. If the interior moisture level exceeds the preset threshold, the method 100 may advance to block 118. In block 118, the power to the device will remain off. In other words the main power supply will remain disconnected from internal electrical or electronic components of the device. An external moisture indicator may be activated to alert the user that moisture is detected within the device. The external moisture indicator may be a light emitting diode (LED) mounted in the body of the device. As described in more detail herein the connection from the moisture detection unit to the LED is waterproof to prevent any malfunction because of moisture within the interior of the device. From block 118, the method 100 may return to block 112 to detect another operation of the power button by the user.

In accordance with an embodiment of the present invention, in block 120, a moisture detected bit may be set in response to the interior moisture level exceeding the preset threshold. The moisture detected bit may have to be reset prior to the device being powered on. The moisture detected bit may be required to be reset by an authorized service provider or vendor. This may provide the vendor or authorized service provider an opportunity to verify that moisture damage has been avoided, confirm the warranty of the device may be maintained, and potentially collect a service fee.

If the interior moisture level does not exceed the threshold in block 116, the method 100 may advance to block 122. In block 122, a determination may be made whether the predetermined capacitive criterion on the surface of the device has been exceeded. If the predetermined capacitive criterion has been exceeded, the method 100 may advance to block 118 and the method 100 may proceed similar to that previously described.

If the capacitive criterion has not been met or satisfied in block 122, the method 100 may advance to block 124 and the device may be powered on.

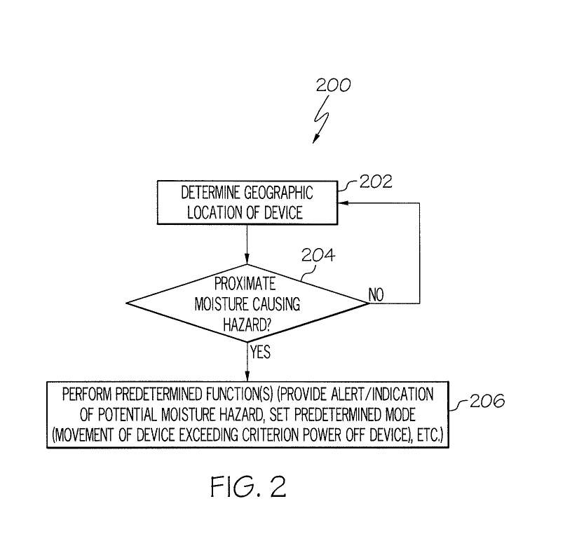

FIG. 2 is a flow chart of an example of a method 200 for providing an alert of a potential moisture or water hazard in accordance with an embodiment of the present invention. In block 202, a geographic location of the device may be determined. Typically, devices, such as smart phones, other cellular telephones, tablet computers and the like include a feature, for example, a Global Positioning System (GPS) device on the phone or computer for determining the location of the device. The GPS device on the device may be able to detect whether the user is in a laundry room, in a bathroom in the house, by a pool or other source of water. Such locations may be considered a potentially hazardous zone for the device.

In block 204, a determination may be made whether the device is proximate to a potential moisture or water causing hazard or in a moisture hazardous zone. If the device is not proximate to a moisture causing hazard or in a moisture hazardous zone, the method 200 may return to block 202 where the device may continue to track the geographic location of the device. If the device is proximate a moisture causing hazard or potential hazardous zone, the method 200 may advance to block 206.

In block 206, a predetermined function or functions may be performed. For example, an alert or indication of the potential moisture or water hazard including type hazard may be provided to the user. An audio alert or indication, visual alert or indication or both may be provided. For instance, a tone or other audible signal may be generated in addition to a text message on the display or touchscreen of the device identifying the type of hazard, location of the hazard as well as other information that may be of interest.

A predetermined mode of operation of the device may also be set in block 206. For example, any movement of the device that exceeds a predetermined criterion or condition may immediately power off the device. A sudden drop of the device in a laundry room or by a pool may be interpreted as dropping the device into a washing machine or into the pool. Accordingly, the system would power off the device immediately.

FIG. 3 is a block schematic diagram of an example of an electronic device 300 including a feature 302 for preventing moisture damage to the device 300 in accordance with an embodiment of the present invention. The methods 100 and 200 may be embodied in and performed by the device 300. The exemplary device 300 may be a communications device, such as a smart phone, tablet computer, lap top or similar device. The device 300 may include a processor and control logic unit 304. The processor and control logic unit 304 may be a microprocessor or the like. A memory 306 or computer readable storage medium may be associated with the processor and control logic unit 304. The memory 306 may include data structures or software programs or code including computer-executable or computer-readable instructions to control operation of the device 300 and its components. The data structure or software programs 306 may include computer-executable instructions for carrying out the functionality similar to that described herein. For example, the data structures and software programs 306 may include a module 308 or modules for monitoring and detecting moisture and preventing moisture damage to the device similar to that described herein. At least some of the blocks or modules of the method 100 in FIG. 1 and the method 200 in FIG. 2 may be embodied in the module 308.

The device 300 may include an operator or user interface 310 to facilitate controlling operation of the device 300 including but not necessarily limited to performing specific functions associated with initiating and conducting phone calls, and other functions. The user interface 310 may include a display 312 to provide visual signals to a user as to the status and operation of the device 300. Similar to that previously discussed the display 312 may be a touchscreen for monitoring and detecting a predetermined capacitance criterion or criteria on a surface of the device as well as receiving user inputs for control of the device 300. The touchscreen 312 and predetermined capacitance criterion may be adapted to detect the drop scenario, the device 300 being dropped into water or other liquid, and the spill scenario, water or other liquid being spilled on the device 300, similar to that previously described.

The user interface 310 may also include a keypad 314 or keyboard and function keys or buttons 316. The keypad 314 or keyboard and functions keys or buttons 316 may be presented on the display 314 in the case of a touchscreen display. The keypad 314 or keyboard, function buttons 316 may permit the user to communicate commands to the device 300 to dial phone numbers, initiate and terminate calls, establish other communications, such as access to the Internet, send and receive email, text messages and the like.

The user interface 310 may also include a microphone 320 and a speaker 322. The microphone 320 may receive audio or acoustic signals from a user or from an acoustic source, such as a radio, television or the like. The microphone 320 may convert the audio or acoustic signals to electrical signals. The microphone 320 may be connected to the processor and logic unit 304 wherein the processor and logic unit 304 may convert the electrical signals to baseband communication signals. The processor and control logic unit 304 may be connected to a transmitter 324 that may convert baseband signals from the main processor and control logic unit 304 to radio frequency (RF) signals. The transmitter 324 may be connected to an antenna assembly 325 for transmission of the RF signals to a communications medium or system, cellular system or network 326 or similar wireless communications system to establish communications with other devices, such as a device 327, server or the like.

The antenna assembly 325 may receive RF signals over the air and transfer the RF signals to a receiver 328. The receiver 328 may convert the RF signals to baseband signals. The baseband signals may be applied to the processor and control logic unit 304 which may convert the baseband signals to electrical signals. The processor and control unit 304 may send the electrical signals to a speaker 322, which may convert the electrical signals to audio signals that can be understood by the user, or the processor and control unit 304 may convert the signals to other signals for presentation on the display 312, such as text messages, data from a website or other information.

The device 300 may also include an external capacitance sensor 329 or sensors for monitoring and/or detecting the predetermined capacitance criterion on the surface of the body of the device 300. Similar to that previously described, a conductive band 331 may be disposed around a perimeter of the device 300 or a similar moisture detection arrangement on the body of the device 300 may be used for monitoring and/or detecting the predetermined capacitance criterion on the body of the device 300. The conductive band or other arrangement may be coupled to a capacitance sensor for monitoring the predetermined capacitance criterion and determining if the predetermined capacitance criterion has been met or satisfied. The capacitance sensor 329 and conductive band 331 and touchscreen display 312 may be adapted to detect the drop scenario or spill scenario for determining if the predetermined capacitance criterion has been met or satisfied for immediately powering off the device 300.

After the device 300 has been automatically powered off in response to detecting the predetermined capacitance criterion being met or satisfied, the device 300 should not be powered on if there is moisture inside the device that could cause permanent damage. If electrical current is applied to the processor and control logic unit 304 and other electronic or electrical components within the device 300 permanent damage to the device could result. To prevent this situation, the feature 302 for preventing moisture or water damage to the device 300 may include a moisture detection system 330. The moisture detection system 330 may include a moisture detection unit 332 and an interior moisture sensor 334 or sensors coupled to the moisture detection unit 332. The moisture detection unit 332 may include a small power source or battery 336 that provides power to a logic circuit 338. The logic circuit 338 may control operation of the moisture detection unit 332 and may receive signals from the interior moisture sensors 334 to monitor moisture or water within the interior of the device 300 and prevent moisture damage to the device 300 similar to that described herein. A main power source 340 may be connected to the processor and control logic unit 304 and other components of the device 300 through the moisture detection unit 332. A power on button 342 may also be connected to the moisture detection unit 332. A user may operate the power on button 342 to connect or reconnect the main power source 340 to the processor and control logic unit 304 after the device 300 is automatically powered off in response to detecting the predetermined capacitance criterion. However, the logic circuit 338 will prevent the main power source 340 from being reconnected to the processor and control logic unit 304 and other electronic circuitry of the device 300 in response to the moisture level within the interior of the device 300 exceeding a preset threshold.

The moisture detection system 330 may also include an external moisture indicator 344 or alerting device, such as an indicator light emitting diode (LED) mounted through the body or housing of the device 300. The external moisture indicator 344 or LED may be activated or illuminated to alert the user that moisture is being detected within the interior of the device 300 and that the device 300 will remain powered off until no moisture is detected within the device 300 or the moisture level is below the preset threshold so the device 300 will not be damaged if power is restored. In another embodiment, a moisture detected bit may have to be reset before power may be restored to the device 300.

The moisture detection unit 332, external moisture indicator 344 and any other components of the moisture detection system 330 that may be adversely impacted by moisture may be enclosed or sealed in a waterproof covering 346 or housing. For example, these components may be sealed in a waterproof coating, such as vinyl or other waterproof material to allow them to function in the presence of moisture.

The moisture detection unit 332 may also set a “moisture detected” bit in response to the moisture level within the interior of the device 300 exceeding the preset threshold. Once the moisture detected bit has been set, it may be required that the device 300 be serviced by an authorized service provide or the vendor to clear the error condition or reset the bit and power the device 300 back on. This may provide the vendor or authorized service provider an opportunity to verify that moisture damage has been avoided, confirm the warranty of the device may be maintained, and collect a service fee.

The device 300 may also include a GPS device 348 or other mechanism for determining a geographic location of the device 300. A module stored on the memory 306 and operable on the processor and control logic unit 304 may use information from the GPS device 348 to determine if the device 300 is near any moisture causing hazard or water hazard. The module may perform operations similar to those described in method 200 in FIG. 2. For example, an alert or notification of the moisture or water hazard may be provided to the user and a device mode may be set to immediately turn off the device 300 if a movement of the device 300 is detected by an accelerometer 350 that the device 300 may be falling into water or another liquid.

The layout and design illustrated in FIG. 3 is for purposes of explaining the present invention and the present invention is not limited to any particular design. While the device 300 illustrated in FIG. 3 is a wireless communications device, the present invention may also be applicable to wired or hard wired communication devices and systems.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to embodiments of the invention in the form disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

What is claimed is:

1. A method for preventing moisture damage to electronic circuitry of a device, comprising:
monitoring for a predetermined capacitance criterion on a surface of the device; and
automatically powering off the device in response to detecting the predetermined capacitance criterion.

2. The method of claim 1, further comprising utilizing a touchscreen for monitoring for the predetermined capacitance criterion.

3. The method of claim 1, further comprising utilizing a capacitance sensor for monitoring for the predetermined capacitance criterion on the surface of a body of the device.

4. The method of claim 3, further comprising utilizing a conductive band disposed around a perimeter of the device, wherein the conductive band is coupled to the capacitance sensor for monitoring the predetermined capacitance criterion on the body of the device.

5. The method of claim 1, wherein the capacitance criterion is configured to avoid powering off the device in response to an amount of moisture detected contacting the surface of the device being below a preset threshold.

6. The method of claim 1, further comprising monitoring a moisture level within an interior of the device.

7. The method of claim 6, further comprising automatically powering off the device in response to detecting the moisture level within the interior of the device exceeding a preset threshold.

8. The method of claim 6, further comprising preventing the device from being powered on in response to a moisture level within the interior of the device exceeding a preset threshold.

9. The method of claim 6, further comprising activating an external moisture indicator in response to the moisture level within the interior of the device exceeding a preset threshold.

10. The method of claim 6, further comprising setting a moisture detected bit in response to the moisture level within the interior of the device exceeding the preset threshold.

11. The method of claim 10, further comprising requiring the moisture detected bit to be reset before the device can be powered on.

12. The method of claim 11, further comprising requiring an authorized service provider to reset the moisture detected bit.

13. The method of claim 1, further comprising:
providing a moisture detection system within an interior of the device; and
preventing the device from being powered on in response to the moisture detection system detecting a moisture level within the interior of the device exceeding a preset threshold.

14. The method of claim 13, wherein providing the moisture detection system comprises:
providing a moisture detection unit enclosed in a waterproof covering, the moisture detection unit comprising a logic circuit and a power source for powering the logic circuit;
providing an interior moisture sensor connected to the logic circuit, wherein the logic circuit receives a signal from the interior moisture sensor and determines the moisture level within the interior of the device based on the signal, the logic circuit preventing a main power source from being connected to the electronic circuitry of the device in response to the moisture level within the interior of the device exceeding the preset threshold; and
providing an indicator light emitting diode (LED), wherein the indicator LED is activated in response to the moisture level within the interior of the device exceeding the preset threshold.

15. The method of claim 1, further comprising:
determining a geographic location of the device; and
performing a predetermined function by the device in response to the device being proximate to a moisture causing hazard.

16. The method of claim 15, wherein the predetermined function comprises at least one of:
setting a particular mode of the device; and
providing an alert or indication of the moisture causing hazard.

17. The method of claim 16, wherein setting the particular mode comprises:
enabling detection of a movement of the device exceeding a certain criterion; and
automatically powering off the device in response to the movement of the device exceeding the certain criterion.

18. A method for preventing moisture damage to electronic circuitry of a device, comprising:
monitoring for a predetermined capacitance criterion on a surface of the device;
monitoring a moisture level within an interior of the device;
automatically powering off the device in response to at least one of detecting the predetermined capacitance criterion on the surface of the device or detecting the moisture level of the interior of the device exceeding a preset threshold; and
preventing the device from being powered back on in response to a moisture level within the interior of the device exceeding the preset threshold.

19. The method of claim 18, wherein monitoring for a predetermined capacitance criterion comprises detecting one of the device being dropped into a liquid and the liquid being spilled on the device.

20. A method for preventing moisture damage to electronic circuitry of a device, comprising:
detecting a liquid contacting a surface of the device;
detecting a moisture level within an interior of the device; and
automatically powering off the device in response to an amount of the liquid contacting the surface of the device exceeding a predetermined criterion or the moisture level of the interior of the device exceeding a preset threshold.
